(19) United States
(12) Patent Application Publication
(10) Pub. No.: US 2020/0320357 A1
(43) Pub. Date: Oct. 8, 2020

(54) CONVERTING CALIBRATION DATA

(71) Applicant: HEWLETT-PACKARD DEVELOPMENT COMPANY, L.P., Houston, TX (US)

(72) Inventors: Jan Morovic, London (GB); Peter Morovic, Sant Cugat del Vallers (ES)

(73) Assignee: HEWLETT-PACKARD DEVELOPMENT COMPANY, L.P., Houston, TX (US)

(21) Appl. No.: 16/303,500

(22) PCT Filed: Jul. 29, 2016
(86) PCT No.: PCT/US2016/044637

§ 371 Date: Nov. 20, 2018

(51) Int. Cl. G06K 15/02

(52) U.S. Cl. CPC G06K 15/027; G06K 15/1822; G06K 15/1881

(57) ABSTRACT

A method is described in which colorant-space calibration data for a colorant-space image processing pipeline are determined. The colorant-space calibration data are converted into probability-space calibration data for a probability-space image processing pipeline. The probability-space calibration data are applied to image data processed in the probability-space image processing pipeline.

### BACKGROUND

Printing systems using a probability-space image processing pipeline, such as the Halftone Area Neugebauer Separation (HANS) pipeline, are arranged to output a printed image. For a print operation with a large number of copies, it may be helpful to distribute the print operation across a number of printing systems or elements. In these cases, each printing system or element may produce a different output image based on a common input image. For example, variations in configurations and/or operating conditions may lead to color inconsistency.

### DESCRIPTION OF THE FIGURES

FIG. 1 is a schematic diagram showing a representation of a Neugebauer Primary area coverage (NPac) vector according to an example;

FIG. 2A is a schematic diagram showing a colorant-space image processing pipeline according to an example;

FIG. 2B is a schematic diagram showing a probability-space image processing pipeline (e.g., HANS pipeline) according to an example;

FIG. 3 is a schematic diagram showing a system using both a colorant-space image processing pipeline and a probability-space image processing pipeline (e.g., HANS pipeline) according to an example;

FIG. 4 is a flow chart showing a method for determining calibration data for a print element in a colorant-space image processing pipeline according to an example;

FIG. 5 is a flow chart showing a method for generating a calibrated print output in a colorant-space image processing pipeline according to an example;

FIG. 6 is a flow chart showing a method for determining the reference print element in a colorant-space image processing pipeline according to an example;

FIG. 7 is a flow chart showing a method for outputting calibration data for a print element in a colorant-space image processing pipeline according to an example;

FIG. 8 is a flow chart showing a method for outputting a set of colorimetric-deposition relationships for print elements in a colorant-space image processing pipeline according to an example;

FIG. 9 is a flow chart showing a method for applying a colorant-space calibration data to a probability-space pipeline according to an example;

FIG. 10 is a flow chart showing a method for generating a colorant-space-to-probability-space mapping according to an example;

FIG. 11 is a schematic diagram showing a probability-space image processing pipeline (e.g., HANS pipeline) using colorant-space calibration data according to an example;

FIG. 12 is a schematic diagram showing a system using a probability-space image processing pipeline and colorant-space calibration data according to an example;

FIG. 13 is a schematic diagram showing a computer system capable of implementing a probability-space image processing pipeline and colorant-space calibration data according to an example.

### DETAILED DESCRIPTION

Hereinafter, examples are mainly directed to printing systems and methods, e.g., using ink-jet printers, laser printers, xerographic printers, three-dimensional (3D) printers or other printers.

Print is a method that permits to represent images to human eye or obtain objects. Print may be bi-dimensional (2D) print or three-dimensional (3D) print. 2D print may be the result of a number of colorants of different colors disposed on top of a substrate (e.g., paper). Colorant (e.g., ink) amounts are chosen for each printable color. With 3D print, a three-dimensional object may be obtained by printing on a bed of build material. A printing system may include a printer, which may be a 2D printer or a 3D printer. In certain cases, the printer may be an inkjet printer, for example a scanning inkjet printer or a page wide array printer. The printing system may comprise a plurality of print elements. A print element may be a print head or die. A page-wide printer may use, for example, an array of print heads, each print head being a print element. A print head may consist of a plurality of nozzles, for example a print head may consist of silicon pieces known as dies in which the printing nozzles are formed. Each nozzle may be arranged to deposit drops of a printing fluid, such as ink, gloss or varnish. There may be a set amount of ink that is released in each drop, e.g., a large drop may have a different volume of ink to a small drop. Certain printers may deposit a plurality of ink drops when an instruction is received to actuate the nozzles, e.g., the printer may receive a command based on image data to deposit drops of ink for a given pixel. The volume of ink released by a nozzle in a single drop may be referred to as its ink drop density. It may be assumed that the ink drop density across a given die is constant, and also assumed that the ink drop density across many dies may be different. For example, some print heads may allow drops of different sizes to be ejected. Therefore the many dies (and therefore print heads) may be calibrated.

A color may be defined with reference to a particular representation model, such as Red-Green-Blue, RGB, color space or Cyan-Magenta-Yellow-Black, CMYK, color space. Other color models include the International Commission on Illumination (CIE) 1931 XYZ color space, wherein three variables (‘X’, ‘Y’ and ‘Z’ or tristimulus values) are used to model a color, and the CIE 1976 (L*, a*, b*-CIELAB) color space, wherein three variables represent lightness (‘L*’) and opposing color dimensions (‘a*’ and ‘b*’).

A colorant is a print material, e.g., ink, toner, fluid, varnish, etc. The colorant may also be defined with reference to a color space (which, in this case, may also be referred to as colorant space), which comprises the colors that may be obtained by a particular printer (or computed in a particular printing system). For example, a black/white printer which applies one single drop per pixel defines one single colorant.

A colorimetric value may relate to an observable or measurable quantity of color output provided by a printer. An older printer may produce a lighter, less colorful perceived color than a color produced by a newer printer.

Examples described herein relate to configuring and/or calibrating a printing system. Calibrating a printing system modifies its print output. Calibration may be performed according to calibration data for a print element. Calibrating a printing system may modify colorant-deposition characteristic for a printer. For example, calibration may modify the ink drop density output by a printer for a given colorant. Applying a calibration to a printing system may modify a print element's colorimetric characteristics so as to shift those characteristics according to a reference.

Examples described herein relate to determining calibration data for a print element, e.g., based on a reference print element. Certain examples are described where the reference print element relates to a darkest print element. Certain examples described herein may also be applied to a calibration based instead on using a lightest print element. A reference print element may be used as a reference for calibrating a printing system. In some examples, the calibration may be a normalization with respect to the colorant value of a particular pixel or group of pixels, e.g., the darkest or lightest pixel or group of pixels in an image.

A printing system or method may rely on a sequence of passages forming a pipeline. With a colorant-space image processing pipeline (or colorant-space pipeline), computations are performed on values associated to colorants (e.g., ink) to be deposited onto a substrate.

With a probability-space image processing pipeline (or probability-space pipeline), such as the Halftone Area Neugebauer Separation (HANS) pipeline, color values to be associated to the pixels are treated in terms of probabilities, such as statistical distributions of color states. An original image data may comprise color data as represented in a first color space (e.g., RGB, CMYK, etc.) in which colors are associated to colorants (e.g., inks). Then, the color data may be mapped from the first color space to a Neugebauer Primary area coverage (NPac) color space, so that a resulting image comprises pixels whose color values are defined in terms of NPac vectors that specify probability distributions for different halftone-pixel states. An image on a substrate comprises a plurality of pixels or dots; each pixel may be assigned to a particular vector of probabilities. Each Neugebauer Primary (NP) is therefore a “color primary”: the image to be represented is made of a collection of multiple NPs (each having a particular probability of being assigned to each pixel).

In a binary (bi-level) color system (e.g., a printer which produces one single drop of one single ink for each pixel), a NP can be one of 2^{k} combinations of k inks within the printing system. If a printing device uses Cyan-Magenta-Yellow, CMY, inks, eight NPs are defined: C, M, Y, C+M, C+Y, M+Y, C+M+Y, and W (White or Blank indicating an absence of ink, and, therefore, the color of the support, which may be the color, often white, of the paper used for the print). It may also be possible to use multi-level printers, whose print heads are able to deposit N drop levels: a NP may be for example, one of (N+1)^{k} combinations.

A NPac represents a distribution of Neugebauer Primaries (NPs), e.g., over an image or a unit area of the image. In order to define area coverages of NPs, NPac vectors can be used. For each pixel (and/or for each unit area of an image), a component of the vector is associated to a NP; the value of the component represents the probability for the pixel to be assigned to that NP. In some examples, for a unit area, the value of each component of the vector may be proportional to the number of pixels with a specific color in an image area.

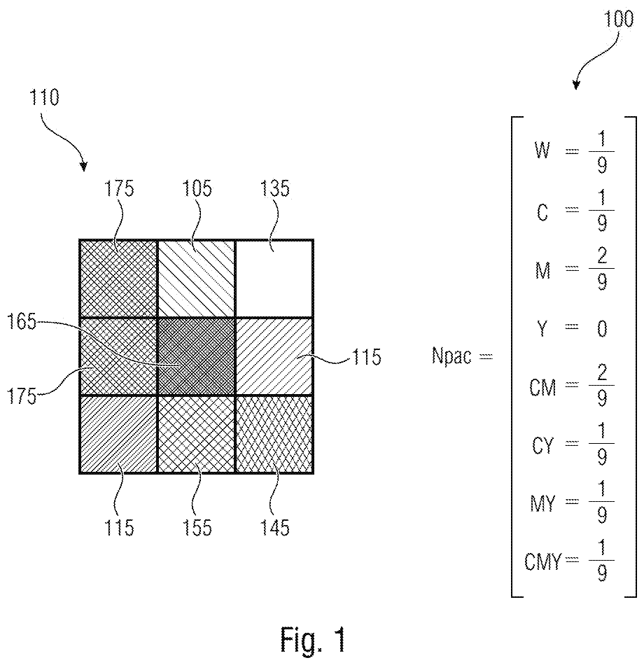

FIG. 1 shows an example of NPac vector 100 for use in a CMY imaging system. An image here comprises a three-by-three pixel area 110. The image may be intended as an image area composed with other image areas to obtain a global image composition.

In the example of FIG. 1, each pixel has the same NPac vector 100 (i.e., for each pixel NP, the probability of taking a particular NP is the same). Hence, the NPac vector 100 may be referred to the particular image area: the value of each component is proportional to the number of pixels which shall take a particular color. The NPac vector 100 defines the probability of eight NPs; for example, in this case: 1/9 for White (W) (135); 1/9 Cyan (C) (105); 2/9 for Magenta (M) (115); 0 for Yellow (Y); 2/9 for Cyan+Magenta (CM) (175); 1/9 for Cyan+Yellow (CY) (145); 1/9 for Magenta+Yellow (MY) (155); and 1/9 for Cyan+Magenta+Yellow (CMY) (165). The pixel area in FIG. 1 may be different in case of a different juxtaposition of the NPs, even though the pixels with the same color are in the same number (although differently displaced).

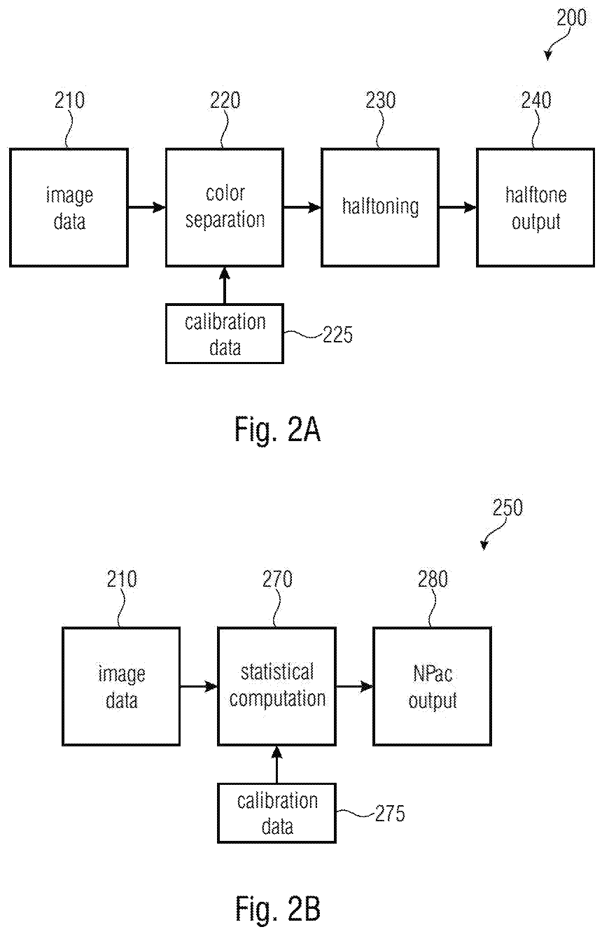

FIG. 2A illustrates a colorant-space pipeline 200. In the example of FIG. 2A, the input is an image data 210 which may comprise color data represented in a generic color space, such as RGB or CMYK.

The color separation component 220 may be a combination of hardware and software which permits to perform the color separation of the image data 210. The color separation component 220 may perform a color separation to obtain values of colorant to be used for the print. The color separation component 220 may map color data from the generic color space to a colorant space (color separation). For example, the colorant space may be a CMYK color space and the color separation may comprise a set of colorant vectors, e.g., each RGB pixel value used for the image data 210 may be mapped to a CMYK pixel value, so as to arrive at a proportion of colorants to be used to generate the image. The proportion of each colorant may be represented, for example, by a fraction (e.g., 0 to 1) or a percentage (e.g., 0 to 100%). The color separation generated by the color separation component 220 comprises continuous tone data: each colorant is denoted using a continuous range.

The color separation component 220 may also perform a colorant-space calibration on the basis of calibration data 225 so as to map nominal colorant values into calibrated colorant values.

A halftoning component 230 may perform halftoning to the values of colorant, so as to obtain actual colorant amounts to be printed. The halftoning component 230 may be a combination of hardware and software which implements a halftoning function. Halftoning may permit representing an image, originally expressed as continuous tones/intensities (e.g., grey scales), by using a limited number of colorants (e.g., black and white). Human eyes tend to filter images. For example, humans perceive patches of black and white marks as some kind of average grey when viewed from sufficiently far away. Hence, the halftoning component 230 may reproduce the continuous tone image output by color separation component 220 represented in the colorant space, e.g., using a series of dot patterns. This may allow the continuous tone image to be printed on a printing device with a discrete number of output drop levels. Accordingly, following the color separation, the halftoning component 230 applies a halftoning operation to the continuous tone data to generate a halftone output 240. The halftoning operation may use a series of geometric patterns to convert the continuous tone data of the color separation to a discrete tone data, e.g., data comprising a discrete number of color levels. For example, if an image is to be printed on a binary level printing device (e.g., with either 0% or 100% colorant per pixel) a halftoning component 230 may generate a halftone output with two discrete tone levels per colorant. A series of dots may be used to replicate continuous tone data, wherein each dot comprises a solid color and a variation in dot size, dot shape and dot spacing simulates a continuous tone when viewed from a distance. A halftone output 240, ready for a print, may be provided by the halftoning component 230.

FIG. 2B shows an example of a probability-space image processing pipeline, e.g., a HANS pipeline 250. The probability-space image processing pipeline 250 makes use of the image data 210 that is passed into a color statistical computation component 270. The image data 210 may comprise color data as represented in a generic color space, such as pixel representations in a first RGB or CMYK color space.

The statistical computation component 270 may map the color data from the generic color space to a probability space. The statistical computation component 270 may be a combination of hardware and software which maps the color data from the generic color space to the probability space. The probability space may comprise a NPac color space. Accordingly, an output color may be defined by a NPac value that specifies a particular area coverage of a particular colorant combination. (This is in contrast to the colorant-space image processing pipeline 200, where color separation is performed to a colorant vector space, and then halftoning is performed on continuous tone data in the colorant vector space to generate an output image.) In the probability-space image processing pipeline 250, a halftone image on a substrate comprises a plurality of pixels or dots and the spatial density of the pixels or dots is defined in the NPac space to control the colorimetry of an area of the image. In the context of a probability space, the term “color separation”, referring to a NPac output, also presents elements of halftoning.

The statistical computation component 270 may use calibration data 275, which, in general, have the same purpose of the calibration data 225 for the colorant-space image processing pipeline 200 of FIG. 2A. In general terms, the data to be used for performing calibrations on pixels expressed in terms of colorants are not necessarily the same of the data used for calibrating performing calibrations on pixels expressed in terms of statistical values.

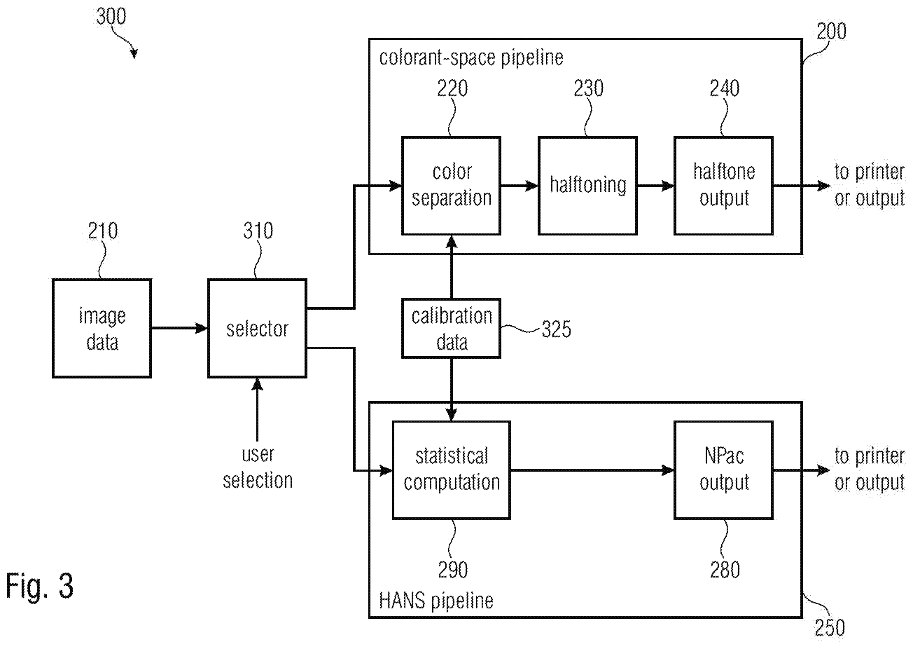

FIG. 3 shows a printing system 300 which may operate with both a colorant-space image processing pipeline 200 and a probability-space image processing pipeline 250. In some examples, a user or a control processor may select a preferred pipeline by acting on a selector 310. Accordingly, the same image 210 may be printed using either the colorant-space image processing pipeline 200 or the probability-space image processing pipeline 250.

Depending on the user's selection, calibration data 325 may be provided either to the color separation component 220 of the colorant-space image processing pipeline 200 or to the color statistical computation component 270 of the probability-space image processing pipeline 250. Calibration data 325 may be the calibration data 225 in a format for the colorant-space image processing pipeline 200. The statistical computation component 290 may convert calibration data 325 (in a format for the colorant-space image processing pipeline 200) into calibration data in a format for a probability-space image processing pipeline 250, so as to obtain a NPac output 280.

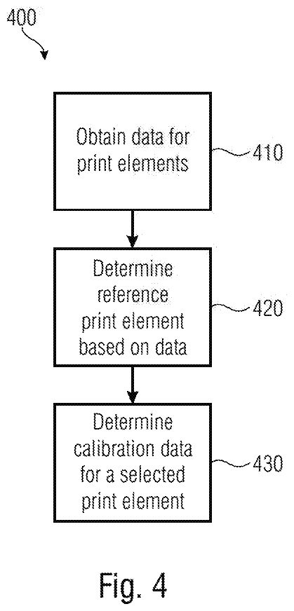

FIG. 4 shows a method for determining calibration data (e.g., 225, 325) for a print element in a colorant-space image processing pipeline, e.g., to be used in color separation component 220 in the colorant-space image processing pipeline 200.

At block 410 source data is obtained for a plurality of print elements. The source data may relate to a set of characteristics of an output generated by a given print element. The characteristics may comprise a colorimetric-deposition relationship. For example, the source data may relate to, for a given print element, a relationship between a colorimetric value and an ink drop density value for the print elements. In certain examples, the colorimetric value may comprise a lightness metric such as a measured lightness for an output printed using a given print element. Each print element may have a different relationship. The relationships may be defined as an array of colorimetric values and associated deposition values and/or by a given mathematical function that may be modelled from measured data.

At block 420 a reference print element is determined based on the source data obtained at block 410. The reference print element may be determined based on the respective plurality of relationships for the print elements. For example, for a given colorimetric value, the reference print element may be determined as the print element having the lowest ink drop density value. In certain examples, the reference print element may the darkest print element for a given ink output or ink deposition value. The colorimetric value may be a lightness metric, such as an L* value in an L*a*b* color space. A reference print element may also be determined based on a statistical measure across the plurality of data points, e.g., may be selected as a print element with the average lowest deposition value. Similarly, a statistical measure may be determined from the function. Conversely, if a calibration is chosen based on a lightest print element, the lightest print element may be selected as a print element with the average highest deposition value.

Once the reference print element is determined, at block 430 the calibration data for a selected print element may be determined. The calibration data (e.g., 225 or 325) determines a deposition of printing fluid for a selected print element with reference to the reference print element. For example, the calibration data may define a transformation of colorimetric-deposition data for a reference print element that enables the calibration of a print element that is not the reference print element. Calibration data may take, for example, the form of a look-up table (LUT) and/or of coefficients to be multiplied to colorant values to be output to different print elements.

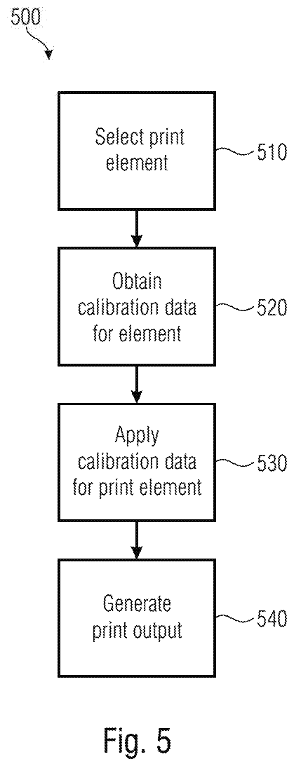

FIG. 5 shows a method 500 for generating a calibrated print output with a colorant-space pipeline (e.g., pipeline 200). This method may be performed, for example, in the color separation component 220 of FIG. 2A, and/or use the calibration data 225 of FIG. 2A or 325 of FIG. 3. The method may use the calibration data (which may also use a LUT) generated by method 400.

At block 510 a print element is selected. For example, a given print element may be selected in a set of print elements for the printing system. The method may be repeated for each print element in the set of print elements.

At block 520 a calibration data (e.g., 225 or 325) for the selected print element is obtained. This operation may comprise retrieving the calibration data generated at block 430 of FIG. 4. The calibration data may be retrieved from a memory or persistent storage device where they have been previously stored.

At block 530 the calibration data is applied to the print element. This operation may set an output printing fluid deposition value for a given colorimetry as a function of the relationship between colorimetry and deposition of printing fluid for a reference print element, e.g., the reference print element determined at block 420 in FIG. 4.

At block 540 a print output is generated. The calibration serves to modify the print output generated by the printing system, i.e., it dictates how the print output is to be generated.

The output of method 500 may be provided, for example, to a halftoning component such as the halftoning component 230 of FIG. 2A or 3.

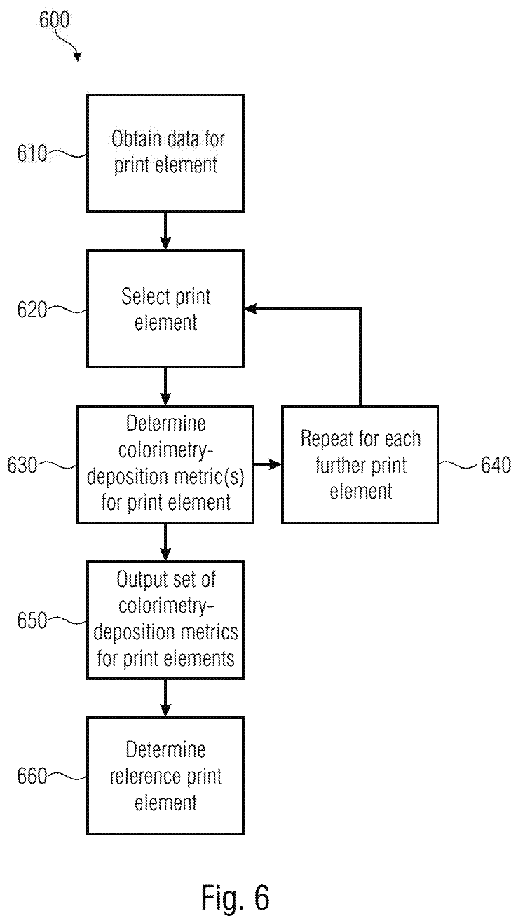

FIG. 6 shows a method 600 for determining a reference print element for a colorant-space pipeline, such as the colorant-space pipeline 200 of FIGS. 2A and 3.

At block 610 data for a plurality of print elements is obtained. This operation may occur in a similar manner to block 410 of FIG. 4. At block 620 a print element may be selected. At block 630 a colorimetry-deposition metric for the selected print element may be determined. This operation may comprise determining a colorimetry-deposition metric that represents a reference print head. Block 640 causes this process to be repeated for each further print element that is yet to be selected. For example, it may be repeated for all print elements in a printing system. Blocks 620, 630 and 640 may be repeated until all print elements in a printing system have been selected and a colorimetric-deposition metric is determined for the plurality of print elements. At block 650 the set of colorimetry-deposition metrics for the plurality of print elements is output. This set of output colorimetry-deposition metrics is used to determine the reference print element at block 660. For example, the lowest metric in the set may be determined and the associated print element may be deemed the reference print element.

Calibration data may be a calibration factor for a print element. As such, each print element may have a different calibration factor. The calibration factor may be determined in relation to a reference print element in the printing system, e.g., it may represent a ratio or other relative measure. The reference print element is then used as a reference for calibrating a selected print element, e.g., it may be used as a general basis for specific print element calibration. The selected print element may be selected from a plurality of print elements in a printing system. The selected print elements may also be selected from a plurality of print elements. When the calibration is applied to the selected print element the ink drop density output by the nozzles of the print element is modified, e.g., the ratio or other relative measure may scale a defined ink drop density for the reference print element.

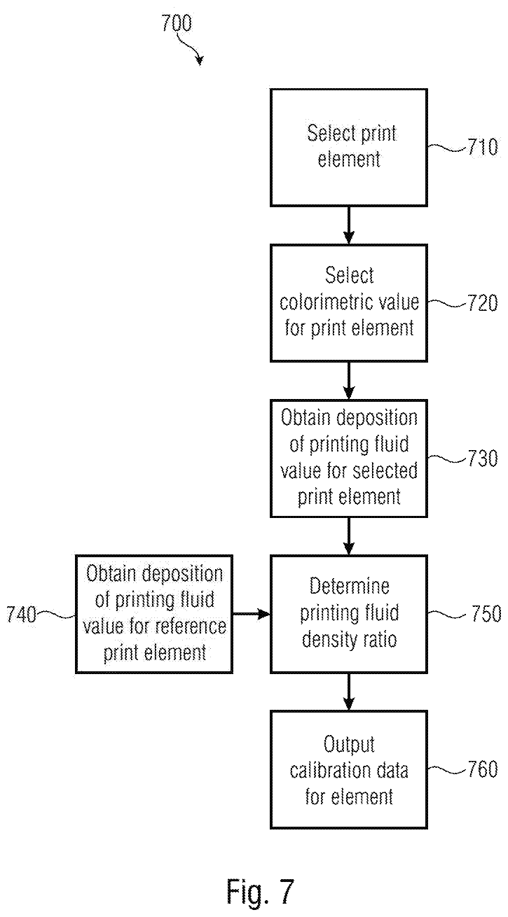

FIG. 7 shows a method 700 for outputting calibration data for a print element according to an example based on a colorant-space pipeline (e.g., pipeline 200).

At block 710 a print element is selected. At block 720 a colorimetric value is selected for the print element. This colorimetric value may comprise one of a plurality of sample points or a single selected sample point. For example, if the colorimetric value comprises an L* value in a range of 0 to 100, the colorimetric value may comprise a single sample point, e.g., a value of 50, or one of a range of sample points, e.g., 12, 25 . . . 87, 100. At block 730, for the selected colorimetric value and the selected print element, a deposition of printing fluid value is obtained. This may be achieved experimentally, e.g., the nozzles in the selected print element can be actuated to cause ink drops to be ejected from the nozzles and the resultant ink drops that are deposited on a print target such as paper or acetate or a bed of build material, may be measured to obtain a deposition of printing fluid value. If data representative of deposition characteristics of the print element is provided, this can be sampled at the selected colorimetric value, i.e., first obtain the L* values for the deposition of printing fluid values, then perform the procedure described above with reference to FIG. 7 analytically over the colorimetric-deposition relationships.

At block 740, the selected colorimetric value is used to obtain a deposition of printing fluid value for a reference print element. The reference print element may be determined as per block 420 of FIG. 4 or the method of FIG. 4. For example, a relationship between an L* value and an ink drop density value may be sampled at the selected colorimetric value, i.e., at a given L* value. At block 750 a ratio of printing fluid density may be determined using the deposition of printing fluid values obtained from blocks 730 and 740. This ratio may form part of the calibration data for the selected print element. The ratio may be referred to as a calibration factor for the selected print element. The ratio may be determined based on a deposition of printing fluid value for a reference print element. The ratio may be calculated by dividing the deposition of printing fluid value for the selected print element by the deposition of printing fluid value for the reference print element. In other words, the numerator of the ratio relates to the selected print element to be calibrated and the denominator of the ratio relates to the reference print element which is used as a reference. At block 760 calibration data for the selected print element is output. This may, for a given print element, take the form of a single ratio value or may be a statistical measure across a range of colorimetric values, e.g., may comprise an average and/or filtered deposition ratio value.

The method 700 may be applied to print elements in order to calibrate the respective print elements based on using a reference print element as a reference. The print elements selected may be in the same printing system as the determined reference print elements or the print element selected may be in a different printing system from the reference print element on which the calibration is based.

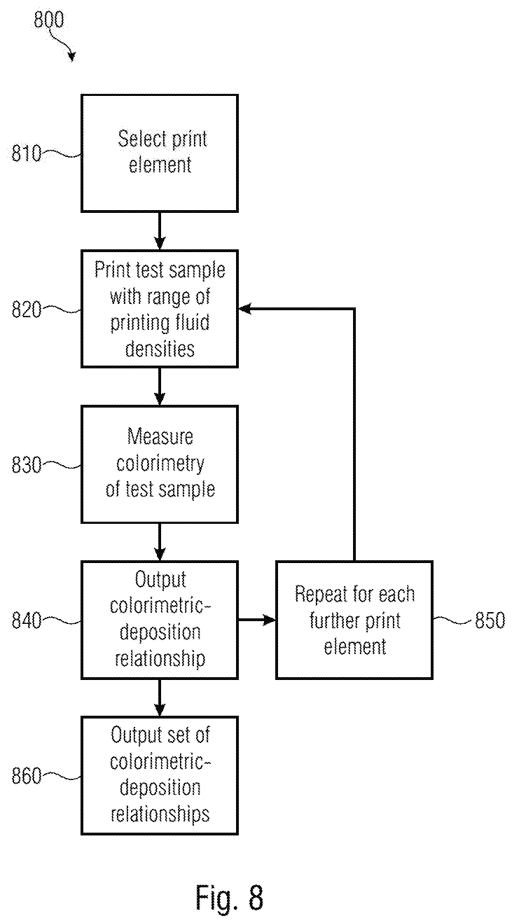

FIG. 8 shows a method 800 for outputting a set of colorimetric-deposition relationships for print elements with a colorant-space pipeline (e.g., pipeline 200).

At block 810 a print element is selected from a plurality of print elements. At block 820 the selected print element is used to print a test sample with a range of printing fluid densities. For example, the density of printing fluid may be increase from a minimum density to a maximum density for the printing fluid of the print element. In a printing system with a range of ink drop values per pixel, e.g., 0 to d drops may be deposited per pixel, this range of ink drop values may be used to define the range of printing fluid densities.

At block 830 the colorimetry of the test sample for the print element is measured. The colorimetry values measured may relate to a lightness metric such as L*. Measurement may be achieved using a colorimeter. A colorimetry value may be obtained at each level of printing fluid density between the minimum and maximum printing fluid densities. This provides a set of colorimetry values for a respective set of printing fluid density values. At block 840 the colorimetric-deposition relationship for the print element is output. With block 850 this process may be repeated to obtain a colorimetric-deposition relationship for further print elements. All print elements may be selected before the full set of colorimetric-deposition relationships are output for all print elements in the printing system at block 860. In some examples, a mathematical function may be fitted to the measured colorimetric values for the defined range of printing fluid density values and the relationship may be defined by the function.

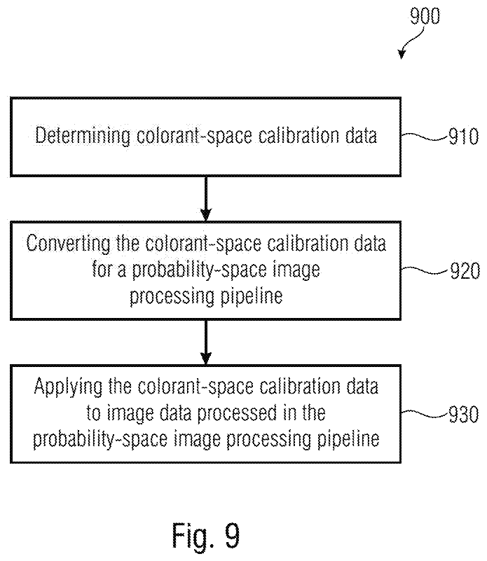

FIG. 9 shows a method 900 for performing calibration in a probability-space image processing pipeline, such as, for example, the HANS pipeline 250 of FIG. 2B or 3.

At block 910, colorant-space calibration data (e.g., 225 or 325) are determined for a colorant-space image processing pipeline (e.g., pipeline 200 of FIGS. 2A and 3). At least one of the methods 400, 600, 700, or 800 may be used.

At block 920, the colorant-space calibration data obtained at block 910 are converted into probability-space calibration data in a format for a probability-space image processing pipeline (such as calibration data 275 in FIG. 2B). This passage may be performed, for example, in the statistical computation component 290 of FIG. 3. Converting may be performed by applying a colorant-space-to-probability-space mapping (which may comprise the use of a LUT) to the colorant-space calibration data.

At block 930, the probability-space calibration data (e.g., 325) are applied to image data (e.g., image data 210 in FIG. 3) processed in the probability-space image processing pipeline (e.g., pipeline 250, in particular in the statistical computation component 290). Accordingly, a probability-space image processing pipeline may make use of colorant-space calibration data.

In some examples, the operations defined by blocks 920 and 930 may be at least partially simultaneous and/or may be performed together with statistical computations (e.g., performed by component 270 or 290) to convert an input image (e.g., image 210) for a probability-space pipeline. For example, a single look-up table (LUT) may be obtained which maps calibrated data into parameters to be used to perform the statistical computations of components 270 and 290. Hence, it is possible to convert an input image (e.g., 210) into an image defined with NPacs using one single LUT (e.g., one single LUT for each print element to be calibrated).

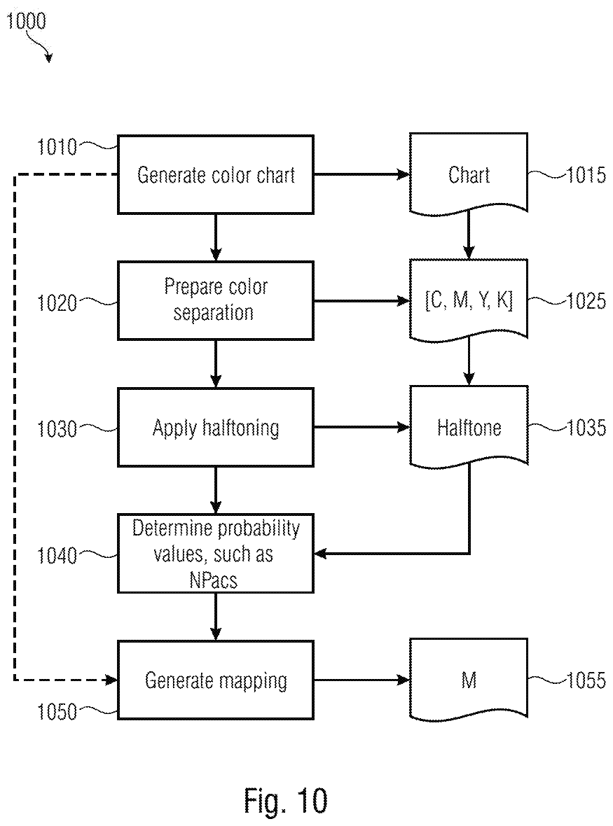

FIG. 10 shows a method 1000 that may be used to permit the realization of blocks 920 and 930, in particular to convert colorant-space calibration data (e.g., obtained at block 910 of FIG. 9) into probability-space calibration data in a format for a probability-space image processing pipeline (e.g., a HANS pipeline). The method 1000 may be used to allow the probability-space image processing pipeline 250 to use the colorant-space calibration data 325, the latter being suitable for a colorant-space pipeline.

FIG. 10 shows how to generate a colorant-space-to-probability-space mapping (which may comprise a LUT), to be used, for example, to perform the conversion of colorant-space calibration data into probability-space calibration data in block 920 of FIG. 9.

At block 1010 a test chart 1015 (which may be a color chart) may be generated. The test chart 1015 comprises test patches. Each test patch may represent a sampling of a color space of a colorant-space image processing pipeline, e.g., each test patch may feature a color value that results from the sampling of the color space. The color space of the colorant-space image processing pipeline may comprise one of a RGB and CMYK color space.

The sampling may be a regular sampling of the color space. For example, in one case, a regular sampling may comprise 17 levels in each color channel of a RGB color space, resulting in 17³, i.e., 4913 test patch colors. In another case, a regular sampling may comprise 9 levels (which may relate, for example, to different intensities of each of the same colorant) in each colorant channel of a CMYK color space, resulting in 9⁴, i.e., 6561 test patch colors. The level of the sampling may be selected based on available resources and the requirements of any particular implementation. The requirements may include, for example, the accuracy level that is desired to represent an image. For example, each test patch may be arranged to have a sufficient pixel count so as to accurately measure any halftone output. In one implementation a 128 by 128 pixel square may be sufficient. Each test patch may have all the pixels of the same color.

At block 1020 in FIG. 10, a color separation 1025 for the test chart 1015 is prepared using the colorant-space image processing pipeline. The color separation 1025 is shown as having CMYK components, i.e., comprises continuous tone data in CMYK colorant space. Other examples may use greater or fewer colorants, or RGB continuous tone data. At block 1030, a halftoning operation is applied to the color separation 1025 using the color halftone processing pipeline to generate a halftone output 1035. In certain cases the halftone output 1035 may comprise data indicative of colorant drop states per halftone pixel, e.g., whether CMYK (or RGB) printer pens are to fire drops in respect of a particular substrate area. The output of the sequence of blocks 1010 to 1030 may therefore be a halftone representation of a chart including a number of test patches.

At block 1040, the halftone output 1035 may be processed to determine probability values, such as NPac values. This operation may comprise, for a selected test patch, determining printing-fluid drop-state statistics for the selected test patch. In certain cases, the drop-state statistics may comprise NP proportions for a predetermined test patch area. In some cases, a NPac vector is determined for each test patch in the chart. At block 1050, these determined NPac values are used for generating a colorant-space-to-probability-space mapping 1055 (which may be a color-space-to-NPac color mapping). For example, if the sampled color values that are used for generating the test patches of the test chart 1015 are known, then these may be mapped to the determined NPac values for each test patch. In FIG. 10, a dashed line between blocks 1010 and 1050 represents the use of known sampled color values in the generation of the color mapping. However, in other cases, the sampled color values may be determined based on a known sampling rate.

The output of the method 1000 is a color mapping between color values in a colorant space and probability values (such as NPac values in a HANS pipeline).

The mapping 1055 may comprise a LUT with a plurality of nodes, wherein each node represents the mapping from a particular input color value (e.g., associated to a particular patch) to a particular output NPac value. For the examples with 17 and 9 sampling levels, the resultant LUTs may respectively comprise 4913 and 6561 nodes.

When a colorant-space-to-probability-space mapping is obtained (e.g., mapping 1055 obtained with method 1000), it is possible to convert the colorant-space calibration data into probability-space calibration data in a format for a probability-space image processing pipeline.

On the basis of the results of method 1000, it is possible to convert calibration data (e.g., calibration data 225 in FIG. 2A or 325 in FIG. 3, and/or the calibration data obtained at blocks 430 or 760), originally determined for a colorant-space pipeline, to probability-space calibration data for image data processed in a probability-space image processing pipeline 250 (such as a HANS pipeline). Accordingly, blocks 920 and 930 of FIG. 9 may be performed.

When mapping 1055 comprises a LUT, for example, it is possible to transform colorant-space calibration data into values in a format for a probability-space image processing pipeline (such as a HANS pipeline) by finding, in a memory storing the LUT, values associated to different nodes. Notably, it is possible to use one single LUT which maps the input 210 of FIG. 2B into NPacs and, at the same time, performs a calibration of the print elements.

It is possible compute probability values of pixels (NPacs) for each node by interpolation of the LUT entries. The end result is a colorant-to-NPac LUT for the nominal state of the printing system.

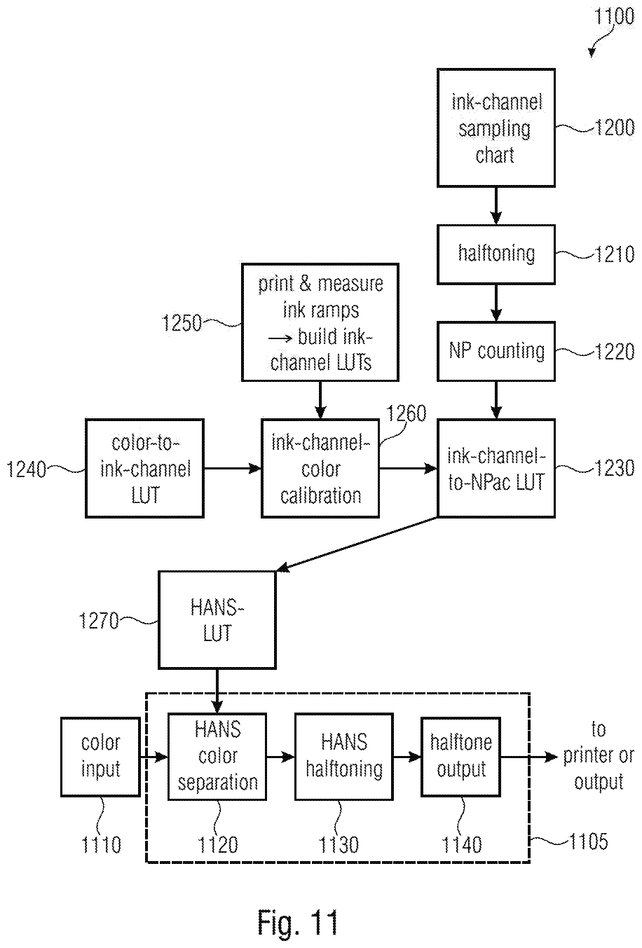

FIG. 11 shows an example with a system 1100 processing images with a probability-space image processing pipeline 1105 (which may be the pipeline 250 of FIG. 3).

The system 1100 may process an input 1110 (which may be, for example, the image data 210 of FIG. 3), which may be a color input.

The system 1100 may comprise a color separation component 1120 (which may be, for example, the color separation component 270 of FIG. 2B or FIG. 3) which may perform, for example, a HANS color separation.

The color separation component 1120 may also operate as a calibration component and calibrate the image data processed in the pipeline 1105, in some cases with the same LUT used for performing the HANS color separation.

The system 1100 may comprise a probability-space halftone component 1130, which may perform, for example, dithering, error diffusion, or matrix halftoning, such as PARAWACS halftoning. In particular when halftoning in the HANS pipeline, a per-pixel determination of the actual Neugebauer Primary to be printed is made. With error diffusion there are iteratively performed comparisons between predetermined pixel values and values bound to per-pixel state probabilities. Subsequently, errors (based on differences between selected color states and per-pixel state probabilities) are diffused to per-pixel state probabilities of subsequent pixels.

A halftone output 1140 may be therefore provided to a printing system with a printer (e.g., having a plurality of print elements to be calibrated), or stored in a memory for future use.

A test chart 1200 (which may be the test chart 1015 of FIG. 10, for example a color chart) may be generated. The test chart 1200 may be a colorant-space chart or ink-channel sampling chart. The test chart 1200 may contain patches (e.g., groups of pixels), each having a plurality of pixels of the same color. For example, the test chart 1200 may be a colorant (ink-channel) chart that is a regular sampling of an appropriate colorant (ink) space (e.g., a 9⁴ sampling of CMYK ink space or a 9⁶ sampling of CMYKcm ink space) and where each patch of the chart is of sufficient pixel count (e.g., 128×128 pixels).

The system 1100 may comprise a halftoning component 1210 which performs colorant-space halftoning to the test chart 1200. The halftoning component 1210 may perform the function performed in block 1030 of FIG. 10.

The system 1100 may comprise a NP counting component 1220 (which may perform the function referred to by block 1040 of FIG. 10). The NP counting component 1220 may determine the NPacs associated to the test patches. For example, the NP counting component 1220 may compute, for each of the test patches of the halftoned version of the test chart 1200, statistics of drop-states (Neugebauer Primaries) and express these NP statistics as proportions per patch, forming NPacs per patch.

This operation may result in the definition of a colorant-to-probability mapping 1230 (which may be, for example, an ink-to-NPac mapping), which may be, for example, mapping 1055 of FIG. 10. In one example, the colorant-to-probability mapping 1230 may be expressed as a regularly-sampled colorant (e.g., ink) indexed LUT that, at each node, contains a probability value (e.g., NPac) corresponding to a given colorant (e.g., ink) amount combination.

The system 1100 may also comprise a color separation component 1240. The color separation component 1240 is to convert colors into colorants (e.g., inks), and, therefore, may operate as a color-to-colorant mapping. The color separation component 1240 may be embodied, for example, by a LUT (which may be, for example, a color-to-ink-channel LUT). The LUT may be, for example, a uniform kⁿ LUT, where n=3 for a device RGB and/or n=4 for a device CMYK interface and where k is the number of levels in the regularly-spaced LUT (e.g., 9, 17, 33).

The system 1100 may also comprise a print-and-measure component 1250. The print-and-measure component 1250 may control the execution of a print of images (e.g., ramps) and their detection. Block 830 of FIG. 8 may be performed using the print-and-measure component 1250. Colorimetric-deposition relationships for each print element may therefore be obtained.

The system 1100 may also comprise a colorant-space calibration component 1260 (which may perform at least some of methods 400, 500, 700, 800).

It is possible to build a probability-space mapping 1270 which may be used in the color separation component 1120. The probability-space mapping 1270 may be implemented by a HANS mapping (e.g., HANS LUT), which transforms the colorant-space input 1110 (or image data 210 in FIGS. 2B and 3) into probability values of pixels (NPacs) to be subsequently printed. In one example, component 1270 is a colorant-to-probability mapping (ink-channel-to-NPac mapping, which may be embodied, for example, by an ink-channel-to-NPac LUT). When n inks are implied, the ink-channel-to-NPac mapping may be in the form of n 1-dimension LUTs (vectors), e.g., mapping nominal colorant (ink) amounts to calibrated colorant amounts.

The probability-space mapping 1270 may be built according to the following method:
1. For each node of the LUT of the color separation component 1240 (color-to-ink-channel LUT), perform a colorant-space calibration (e.g., using the calibration component 1260) to obtain colorant vectors.
2. For each of the obtained colorant vectors (ink-channel vectors), apply the colorant-to-probability mapping 1230 (ink-channel-to-NPac mapping or LUT) to obtain NPacs.
3. The combination of the color values of the obtained LUT and the obtained NPacs forms a color-calibrated HANS LUT.

Accordingly, it is possible to use one single LUT for performing both calibration and HANS separation.

In some examples, one of the LUTs 1240, 1260, 1230, and 1270 may be stored in a memory for future uses.

With reference to FIG. 3, it is possible to note that calibration data 325 are the same for both the colorant-space image processing pipeline 200 and the probability-space pipeline 250. Accordingly, the same calibration data can be used for different pipelines. Hence, a calibration specific for the HANS pipeline may be unnecessary: the calibration in the colorant space may be performed and the relevant data may be simply converted into HANS data (e.g., using the mapping 1055, the block 920, and/or the HANS LUT 1270).

It is also possible to migrate from a legacy system based on a colorant-space image processing pipeline to a system that uses a probability-space pipeline (e.g., HANS pipeline). For example, system 300 of FIG. 3 may be a system in which the colorant-space pipeline 200 and the colorant-space calibration data 325 are pre-existing, while the HANS pipeline 250 has been manufactured or implemented subsequently. Notwithstanding, there is no necessity of obtaining new calibration data specifically obtained with the HANS pipeline: the calibration data 225 may be also used for the HANS pipeline 250.

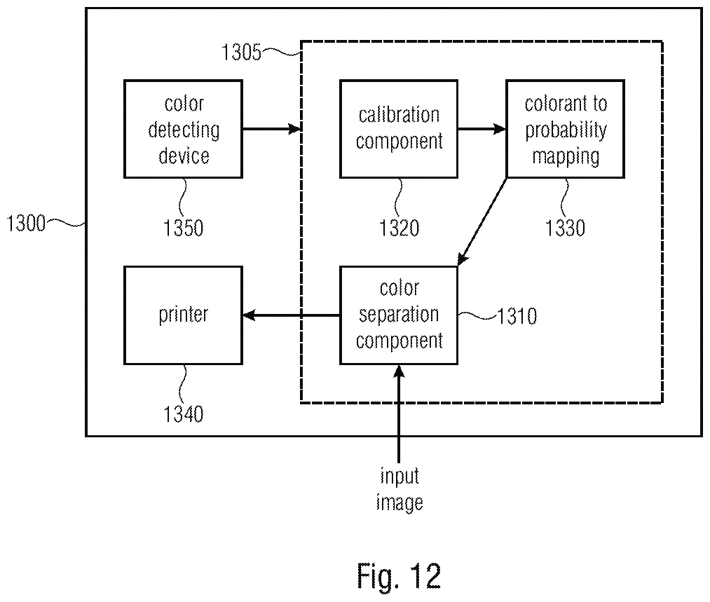

FIG. 12 shows a system 1300. The system 1300 comprises a subsystem 1305 which may comprise, for example, the system 300 or 1100. The subsystem 1305 may comprise a plurality of components interconnected with each other. Each component may be a combination of hardware and software which permits to perform a particular function, such as color calibration, HANS separation, and so on.

The system 1300 may comprise a probability-space color separation component 1310 (which may be, for example, the color separation component 270, 290 or 1120). The probability-space color separation component 1310 may have a probability-space mapping (such as a LUT) which transforms an input image (e.g., 210 or 1110) into a statistic distribution of colors for the pixels (e.g., NPacs). The system 1300 may have a colorant-space calibration component 1320 (e.g., calibration component 1260) which may map nominal colorant amounts to calibrated colorant amounts in a colorant-space pipeline. The system 1300 may also have a colorant-to-probability mapping component 1330 (e.g., 1230 or 1055) to modify parameters of the probability-space separation component 1310 on the basis of the output of the colorant-space calibration component 1320.

The system 1300 may also comprise a printer 1340, which may perform various print operations, e.g., the operations associated to block 820. The system 1300 may also comprise a color detecting device 1350 which may, for example, permit the measurement function performed at block 830.

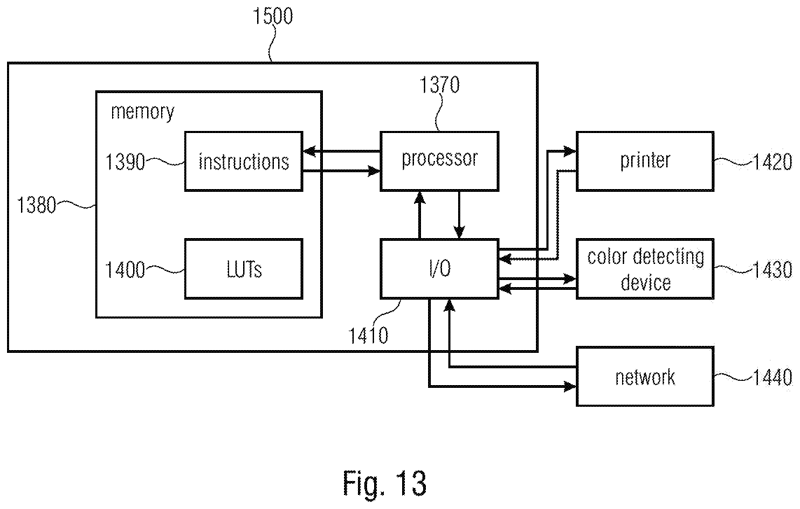

FIG. 13 shows a system 1500 comprising a processor 1370 and a memory 1380 which may be a computer readable storage medium comprising computer readable instructions 1390 that, when executed by the processor 1370, cause the processor 1370 to perform any of the methods shown in FIGS. 2A-10 (or at least some of its blocks) or to control one of the systems 300, 1100, and 1300 (or at least one of its components). The components 13310, 1320, and 1330 may be obtained, for example, as combinations of the processor 1370 and the memory 1380, the latter storing instructions which, when running on the processor 1370, cause the processor to perform the calibration, the colorant-to-probability mapping, and color separation.

The memory 1380 may also contain LUTs used for the components 1260, 1230, 1270, 1055, and 1310-1330.

The system 1500 may also comprise an I/O device 1410 which may be connected to a printer 1420 (e.g., the printer 1340, for example), a color detecting device 1430 (e.g., the color detecting device 1350), and/or a network 1440, such as a LAN or a geographical network. Accordingly, calibration data may be transmitted to different devices.

The instructions 1390, when run by the processor 1370, may cause the processor 1370 to perform, for example using the color-to-colorant LUT, a colorant-space calibration to obtain at least one colorant-space calibration vector. In general, there are defined n 1-dimension vectors for n inks. The processor 1370 may also perform, using the test chart 1200 or 1015, a colorant-space halftoning (e.g., at 1030 or 1210). The processor 1370 may also compute probability values of pixels, NPacs (e.g., at block 1220), associated to the test patches of the halftoned chart, so as to form a colorant-to-probability LUT or colorant-space-to-probability-space LUT 1055 (e.g., at block 1230). The processor 1370 may also determine, using the at least one colorant-space calibration vector and the colorant-to-probability LUT, a HANS LUT 1270 for converting a color input (210 or 1110) into a NPac vector). The obtained NPac vector may then be used for a print job in the HANS pipeline.

Notably, it is possible to use one single LUT for both calibration and HANS separation.

Although some aspects have been described in the context of an apparatus, it is clear that these aspects also represent a description of the corresponding method. Some or all of the methods may be executed by (or using) a hardware apparatus, like for example, a microprocessor, a programmable computer or an electronic circuit.

Depending on certain implementation requirements, examples may be implemented in hardware. The implementation may be performed using a digital storage medium, for example a floppy disk, a Digital Versatile Disc (DVD), a Blu-Ray Disc, a Compact Disc (CD), a Read-only Memory (ROM), a Programmable Read-only Memory (PROM), an Erasable and Programmable Read-only Memory (EPROM), an Electrically Erasable Programmable Read-Only Memory (EEPROM) or a FLASH memory, having electronically readable control signals stored thereon, which cooperate (or are capable of cooperating) with a programmable computer system such that the respective method is performed. Therefore, the digital storage medium may be computer readable.

Some examples comprise a data carrier having electronically readable control signals, which are capable of cooperating with a programmable computer system, such that one of the methods described herein is performed.

Generally, examples may be implemented as a computer program product with a program code, the program code being operative for performing one of the methods when the computer program product runs on a computer. The program code may for example be stored on a machine readable carrier.

Other examples comprise the computer program for performing one of the methods described herein, stored on a machine readable carrier.

In other words, an example of method is, therefore, a computer program having a program code for performing one of the methods described herein, when the computer program runs on a computer.

A further example of the methods is, therefore, a data carrier (or a digital storage medium, or a computer-readable medium) comprising, recorded thereon, the computer program for performing one of the methods described herein. The data carrier, the digital storage medium or the recorded medium are tangible and/or non-transitionary, rather than signals which are intangible and transitory.

A further example of the method is, therefore, a data stream or a sequence of signals representing the computer program for performing one of the methods described herein. The data stream or the sequence of signals may for example be transferred via a data communication connection, for example via the Internet.

A further example comprises a processing means, for example a computer, or a programmable logic device performing one of the methods described herein.

A further example comprises a computer having installed thereon the computer program for performing one of the methods described herein.

A further example comprises an apparatus or a system transferring (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some examples, a programmable logic device (for example a field programmable gate array) may be used to perform some or all of the functionalities of the methods described herein. In some examples, a field programmable gate array may cooperate with a microprocessor in order to perform one of the methods described herein. Generally, the methods are preferably performed by any hardware apparatus.

The apparatus described herein may be implemented using a computer.

The apparatus described herein, or any components of the apparatus described herein, may be implemented at least partially in hardware.

The methods described herein may be performed using a hardware apparatus, or using a computer, or using a combination of a hardware apparatus and a computer.

The methods described herein, or any components of the apparatus described herein, may be performed at least partially by hardware.

The above described examples are merely illustrative for the principles discussed above. It is understood that modifications and variations of the arrangements and the details described herein will be apparent. It is the intent, therefore, to be limited by the scope of the impending patent claims and not by the specific details presented by way of description and explanation of the examples herein.

1. A method comprising:
determining colorant-space calibration data for a colorant-space image processing pipeline;
converting the colorant-space calibration data into probability-space calibration data for a probability-space image processing pipeline; and
applying the probability-space calibration data to image data processed in the probability-space image processing pipeline.

2. The method of claim 1, further comprising:
generating a test chart comprising test patches, each test patch representing a sampling of a color space of the colorant-space processing pipeline;
preparing a colorant-space color separation for the test chart using a colorant-space processing pipeline, the colorant-space color separation comprising continuous tone data in a colorant space;
applying a halftoning operation to the colorant-space color separation to generate a halftone output;
for a selected test patch in the halftone output, determining a probability value for the selected test patch based on statistics for the selected test patch; and
generating a colorant-space-to-probability-space mapping based on the determined probability values for each of the at least one selected test patches,
wherein converting is performed by applying the colorant-space-to-probability-space mapping to the colorant-space calibration data.

3. The method of claim 1, wherein determining colorant-space calibration data comprises:
obtaining source data indicative of a relationship between colorimetry and deposition of printing colorant for a plurality of print elements;
determining a reference print element from a plurality of reference print elements based on the source data; and
determining colorant-space calibration data for a selected print element in the plurality of print elements based on the source data, the colorant-space calibration data calibrating deposition of printing colorant for the selected print element with reference to the reference print element.

4. The method of claim 1, wherein the probability values are Neugebauer Primary area coverage, NPac, values.

5. The method of claim 1, further comprising performing a probability-space color separation using the calibrated color data.

6. The method of claim 1, wherein applying the probability-space calibration data to image data processed in the probability-space image processing pipeline is performed using a look-up table, LUT.

7. The method of claim 1, further comprising performing a print job and measuring colorimetry values in the print job.

8. The method of claim 1, wherein determining colorant-space calibration data comprises building a probability-space mapping by
for each node of a colorant-space color separation LUT, performing a colorant-space calibration to obtain colorant vectors;
for each colorant vector, applying a colorant-to-probability mapping to obtain NPacs;
forming a color-calibrated Halftone Area Neugebauer Separation, HANS, look-up table, LUT, from the colorant vectors and the NPacs.

9. A system comprising a processor, a storage coupled to the processor, and computer readable instructions which, when running on the processor, cause the processor to:
perform a probability-space color separation to transform an input image into a statistical distribution of color states;
perform a colorant-space calibration to transform nominal colorant amounts into calibrated colorant amounts; and
perform a colorant-to-probability mapping to modify parameters of the probability-space color separation on the basis of the result of the colorant-space calibration.

10. The system of claim 9, wherein the computer readable instructions, when running on the processor, further cause the processor to:
perform a colorant-space halftoning to a test chart comprising test patches, each test patch representing a sampling of a color space of a colorant-space halftone processing pipeline;
output colorant probability distributions for pixels on the basis of statistical distributions of the colorant in the halftone,
so as to obtain parameters to perform the colorant-to-probability mapping.

11. The system of claim 9, wherein the computer readable instructions, when running on the processor, further cause the processor to perform the colorant-to-probability mapping using a look-up table, LUT.

12. The system of claim 9, further comprising a processor to: determine colorant-space calibration data for a colorant-space image processing pipeline;
convert the colorant-space calibration data into probability-space calibration data for a probability-space image processing pipeline; and
apply the probability-space calibration data to image data processed in the probability-space image processing pipeline

13. The system of claim 9, further comprising print elements.

14. The system of claim 9, further comprising a device to detect and measure colorimetry values in a print job.

15. A computer readable storage medium comprising computer readable instructions that, when executed by the computer, causes the computer to:
perform, using a color-to-colorant look-up table, LUT, a colorant-space calibration to obtain a colorant-space calibration vector;
perform, using a test chart comprising multiple test patches, a colorant-space halftoning;
determine Neugebauer Primary area coverages, NPacs, associated to the test patches of the halftoned chart to form a colorant-to-probability LUT;
determine, from the colorant-space calibration vector and the colorant-to-probability LUT, a Halftone Area Neugebauer Separation, HANS, LUT, to convert a color input into a NPac vector.
